(19) United States
(12) Patent Application Publication
(10) Pub. No.: US 2026/0136055 A1
(43) Pub. Date: May 14, 2026

(54) AIRCRAFT INFLIGHT ENTERTAINMENT SYSTEM SELECTIVELY HANDLING DELIVERY OF PASSENGER NOTIFICATIONS BASED ON DEFERRED ANNOUNCEMENT RULES

(71) Applicant: Thales Avionics, Inc., Irvine, CA (US)

(72) Inventors: Frijo Franco, Tustin, CA (US); Jueren Ma, Hacienda Heights, CA (US); Ivy Man, Tustin, CA (US)

(21) Appl. No.: 18/944,782

(22) Filed: Nov. 12, 2024

(51) Int. Cl. H04N 21/262; B64D 11/00; H04N 21/214; H04N 21/235; H04N 21/414; H04N 21/472

(52) U.S. Cl. CPC H04N 21/26241; B64D 11/00155; H04N 21/2146; H04N 21/235; H04N 21/41422; H04N 21/472

(57) ABSTRACT

A computer server of an aircraft inflight entertainment system includes at least one network interface, at least one processor connected to communicate through the at least one network interface with VDUs, and at least one memory storing modules executable by the at least one processor. An entertainment module operates to distribute entertainment content through the at least one network interface for playout through the VDUs. A user announcement distribution module operates to distribute user announcements through the at least one network interface to the VDUs for playout as video on display devices and/or audio through audio interfaces. A scheduling module operates to selectively defer distribution of at least part of the user announcements through the at least one network interface to the VDUs based on at least one deferred announcement rule.

### TECHNICAL FIELD

The present disclosure relates to providing notifications through aircraft and other vehicle entertainment systems.

### BACKGROUND

It can be inconvenient for aircraft passengers to experience cabin announcements which disrupt their activities. Such announcements can be provided live by cabin crew and/or as prerecorded announcements by inflight entertainment (IFE) systems. Whether passengers are trying to watch a movie or explore the Internet through a seat video display unit (VDU), listen to music through the VDU, or relax, these announcements can interrupt their focus and create frustration. Additionally, the timing of announcements does not consider the varying needs and preferences of individual passengers. For instance, someone engrossed in watching a movie may find a sudden interruption for announcement jarring. This lack of regard for personal experience can detract from the overall comfort and enjoyment of the flight.

### SUMMARY

Various embodiments of the present disclosure are directed to selectively deferring distribution of different types of user announcements to individually selected VDUs based on deferred announcement rules.

In some embodiments, a computer server of an entertainment system includes at least one network interface, at least one processor connected to communicate through the at least one network interface with VDUs, and at least one memory storing executable modules. An entertainment module operates to distribute entertainment content through the at least one network interface for playout through the VDUs. A user announcement distribution module operates to distribute user announcements through the at least one network interface to the VDUs for playout as video on display devices and/or audio through audio interfaces. A scheduling module operates to selectively defer distribution of at least part of the user announcements through the at least one network interface to the VDUs based on at least one deferred announcement rule.

In a further illustrative embodiment, the scheduling module operates to defer distribution of at least part of a user announcement to an identified one of the VDUs based on triggering display of a query message on the identified one of the VDUs and responsively receiving a query response from the identified one of the VDUs indicating a user's request to defer playout of the user announcement.

In another illustrative embodiment, the scheduling module operates to selectively defer distribution of at least part of a user announcement to the VDUs based on receiving a user announcement including a tag indicating deferability of the user announcement. Based on the tag indicating the user announcement is not to be deferred, the scheduling module distributes the user announcement through the at least one network interface to the VDUs for playout without deferral. In contrast, based on the tag indicating the user announcement can be deferred, the scheduling module stores the user announcement in a queue of deferred announcements, identifies an association between the user announcement and a deferred announcement rule, and distributes the user announcement from the queue for playout by at least one of the VDUs based on when the deferred announcement rule becomes satisfied.

As will be explained in further detail below, the deferred announcement rule may define a requirement that playout be completed before a maximum deferred time limit is reached, before entering or exiting a defined flight phase, before a threshold remaining flight time is reached, before or upon a defined flight service initiation, upon reaching a permitted location along a route (e.g. international airspace for duty free), etc.

These and other example embodiments are disclosed below through the drawings and detailed description. Other computer servers and corresponding methods and computer program products according to embodiments of the present disclosure will be or become apparent to one with skill in the art upon review of the following drawings and detailed description, and are thereby understood to be included as part of this disclosure. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 illustrates a flowchart of operations that may be performed by a computer server of an Inflight Entertainment (IFE) system of FIG. 1 to selectively defer distribution of some types of user announcements in accordance with some embodiments; and

FIG. 2 illustrates a simplified system block diagram of the IFE system that provides IFE content to video display units (VDUs) and selectively defers distribution of some user announcements to the VDUs based on deferred announcement rules in accordance with some embodiments.

### DETAILED DESCRIPTION

In the following detailed description, numerous specific details are set forth in order to provide a thorough understanding of aspects of the invention. However, it will be understood by those skilled in the art that the present invention may be practiced without these specific details. In other instances, well-known methods, procedures, components and circuits have not been described in detail so as not to obscure the present invention.

Although various embodiments are explained herein in the context of controlling delivery of passenger announcements through an In-Flight Entertainment (IFE) system of an aircraft, other embodiments are not limited thereto and may be used with other types of vehicles, including, without limitation, ships (e.g., cruise ships), buses, and trains, and with non-vehicle environments, including, without limitation, sports arenas, conference centers, class rooms, etc. Accordingly, embodiments are not limited to use with passengers but may instead be used for any users. The terms announcements and notifications are used interchangeably and can have the same meaning herein. The term video display unit (VDU) can refer to a seat VDU, such as a seatback VDU facing a passenger seated in a cabin, and also more generally refer to any type of display device including, without limitation, a smartphone, tablet computer, laptop computer, gaming device, or other portable electronic device.

Embodiments of the present disclosure are directed to addressing a longstanding issue related to providing passenger announcements within an aircraft cabin and how to make such announcements more effective when delivered to passengers while making the delivery less interruptive to passengers'activities.

Currently, the majority of passenger announcements in aircraft cabins are conveyed through audio messages played via the aircraft's loudspeakers and headphone interfaces. These announcements fall into various categories, including live Passenger Announcements (PA), Pre-Recorded Announcements (PRAM), and Video Announcements (typically for safety videos).

Currently passengers are forced to watch and listen to all the passenger announcements made by cabin crew, PRAM, and video announcements played out by the IFE. Many of these announcements are not mandatory to listen or watch as they are not required announcements, such as announcements relating to duty free sales, destination informational videos, product/service advertisements, promotions (e.g., airline credit cards), etc.

Operational embodiments of the present disclosure can enable passengers using the IFE system to have the flexibility to skip or defer delivery until later (when a deferred announcement rule become satisfied) of various types of audio and/or video announcements, e.g., non-mandatory announcements.

In one example, a mandatory announcement is delivered to all passengers'VDUs (e.g., as audio, video, or combination) and/or to cabin loudspeakers without deferral but in a single default language, e.g., defined for primary announcement services. The same announcement content is available in other languages which are defined to be non-mandatory announcements. Playout of the non-mandatory announcements can be deferred by passengers and may be selectively delivered to individual VDUs of passengers based on when a deferred announcement rule is satisfied, such as when the passenger selects to skip playout of the non-mandatory announcement in another language, selects to defer playout until the end of a movie or other activity, etc., as explained through further example operations below. Thus, IFE operations provide passengers with the option to skip or schedule playout of some types of announcements and continue their IFE entertainment services being provided at their seats.

Some operational embodiments can improve passenger satisfaction with a flight experience by allowing the passenger to focus on mandatory announcements while deferring non-mandatory announcements until considered more acceptable. Mandatory audio announcements are typically used for essential announcements to all passengers (e.g. safety announcements audio instructions, decompression audio instructions, etc.). Mandatory Video Announcements are typically used for essential announcements to all passengers (e.g. safety videos, immigration informational videos, fasten seatbelt videos, etc.). In contrast, non-mandatory announcements are typically used for non-essential announcements to all passengers (e.g. commercials, promotions, duty free shopping, informative information along route and/or destination, etc).

In some operational embodiments, an IFE server delivers mandatory announcements without allowing conditional deferral or delivers with a higher priority of handling than the non-mandatory announcements. In contrast, the IFE server delivers non-mandatory announcements when one or more deferred announcement rules are satisfied, where the deferred announcement rules can be specific to individual passengers, e.g., passenger defined preferences, passenger responses to queries, passenger activities, etc. In this manner, passengers are better able to focus on important announcements and can be more in control of when non-mandatory announcements are delivered to improve passenger satisfaction. These operations can allow passengers to enjoy inflight entertainment with reduced disruptions from non-mandatory announcements.

Some operational embodiments are now discussed in the context of an illustrative use case in which an IFE server is configured to provide passengers with the ability to skip non-mandatory passenger announcements.

In this example, passengers are watching entertainment content provided by the IFE server through seat VDUs. The entertainment content can include playing video on-demand (e.g., movies, television shows, etc.), playing interactive games, browsing the Internet, and launching other types of applications such as maps. A cabin crew member initiates a passenger announcement using one of the following approaches: crew makes a non-mandatory public address announcement using a handset (e.g., asking passengers for donations to a charity) which is processed through the IFE server for delivery to seat VDUs; or the crew launches through a crew interface (e.g., crew terminal or via an executable program flight script) a pre-recorded announcement (e.g., duty-free shopping opportunity or promotion) which is pre-stored in IFE server memory and causes playout by the IFE server through the seat VDUs.

The pre-recorded announcements can be tagged non-mandatory, such as through metadata of the file stored in the IFE server. Creation of tags and associating tags with pre-recorded announcements can be performed when packaging the announcements by a ground system for delivery with other content (e.g., movies, TV shows, games, etc.) to aircraft IFE servers.

Without the benefit of operational embodiments of the present disclosure, when a passenger announcement is triggered, an “Announcement in Progress” notification is displayed on all seat VDU screens and the entertainment services provided by the IFE server through the seat VDUs is paused. Passenger announcement audio is played out through all cabin speakers spaced apart in the cabin and through all seat VDU audio interfaces (e.g., wired interfaces for passenger wired headphones and wireless (e.g., Bluetooth) interfaces for wireless passenger headsets). Similarly, any passenger announcement video is simultaneously played out through seat VDU display screens.

In some operational embodiments according to the present disclosure, passengers are provided an ability to skip some types of announcements (e.g. via a passenger selectable “Skip” button displayed through the passenger's touch-sensitive seat VDU and which may be displayed with the “Announcement in Progress” notification). A passenger may select the “Skip” button to continue an entrainment service (e.g., movie, game, etc.) through the passenger's seat VDU without interruption while the passenger announcement audio continues to be played out (broadcasted) through the cabin speakers and corresponding audio and any video of the announcement may be played through VDUs of passenger who do not select to skip, e.g., within a threshold time of notification. Thus, for example, When a particular passenger selects the Skip button, audio and/or video for the announcement will not be delivered to passenger's VDU for playout on a display screen and/or audio interface (e.g., for wired or wireless headphone). Responsive to selecting to skip, the “Announcement in Progress” screen is removed and the graphical user interface (GUI) is returned to what was being provided to the passenger through the VDU to resume the entrainment service. The announcement may be permanently skipped for that passenger or may be added to a queue of deferred announcement which are then delivered to the VDU of that passenger when a deferred announcement rule that is associated with one or more of the passenger announcements in the queue becomes satisfied, such as described in further detailed below.

The notification may be displayed in a sub-window while the passenger's entrainment service continues to playout in the main window of the seat VDU for a defined time period, after which if the passenger does not select to skip the notification the IFE server proceeds to playout the passenger announcement in the sub-window or the main window while the entrainment service is paused for that passenger.

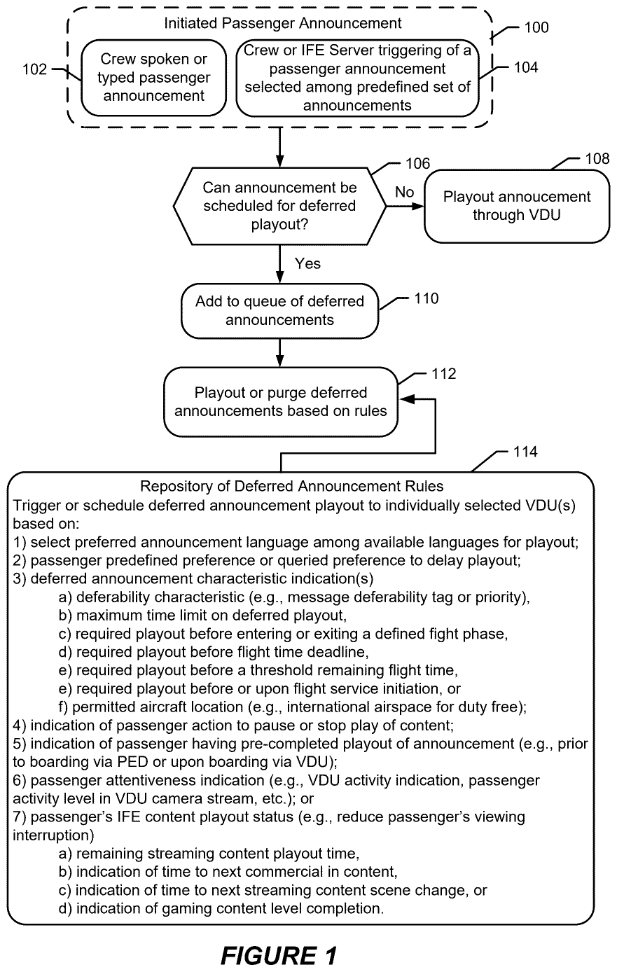

More general embodiments are now discussed with reference to FIG. 1. FIG. 1 illustrates a flowchart of operations that may be performed by a computer server of the IFE system to selectively defer distribution of some types of user announcements in accordance with some embodiments.

In some embodiments the computer server includes at least one network interface, at least one processor connected to communicate through the at least one network interface with VDUs, and at least one memory that stores an entertainment module, a user announcement distribution module, and a scheduling module which are executable by the at least one processor. The entertainment module is operative to distribute entertainment content through the at least one network interface for playout through the VDUs. The user announcement distribution module is operative to distribute user announcements through the at least one network interface to the VDUs for playout as video on display devices and/or audio through audio interfaces. The scheduling module is operative to selectively defer distribution of at least part of the user announcements through the at least one network interface to the VDUs based on at least one deferred announcement rule.

In the non-limiting example of FIG. 1, a passenger announcement is initiated 100, such as by a crew member speaking or typing a passenger announcement 102 through a crew interface (e.g., crew terminal) or by a crew member or the IFE server triggering 104 a passenger announcement selected among a predefined set of announcements, e.g., stored in local memory of the server.

The scheduling module can be operative to selectively defer distribution of at least part of a user announcement to the VDUs based on receiving a user announcement including a tag indicating deferability of the user announcement. Based on the tag indicating the user announcement is not to be deferred, the scheduling module distributes the user announcement through the at least one network interface to the VDUs for playout without deferral. In contrast, based on the tag indicating the user announcement can be deferred, the scheduling module stores the user announcement in a queue of deferred announcements, identifies an association between the user announcement and a deferred announcement rule, and distributes the user announcement from the queue for playout by at least one of the VDUs based on when the deferred announcement rule becomes satisfied.

In the example of FIG. 1, the operations determine 106 whether the passenger announcement can be scheduled for deferred playout or, instead, should be played 108 through the VDUs and cabin speakers without delay. For example, a crew member may press (or not press) a button on a microphone or crew interface to indicate for control of selective distribution 106 that the spoken, typed, or selected announcement is tagged as mandatory and is to be distributed to the VDUs and cabin speakers without deferral. Similarly, the crew member may press another button on the microphone or crew interface to indicate that the spoken, typed, or selected announcement is tagged as non-mandatory and should be added 110 to a queue of deferred announcements that are played out or purged 112 from the queue based on when one or more rules in a repository of deferred announcement rules are satisfied 114.

One or more of the rules in the repository may be associated with particular types of passenger announcements, associated with all types of deferrable announcements, and/or associated with defined types of characteristics which are known about identified passengers (e.g., passenger's preferences for receiving announcements, passenger's loyalty program status with an airline, passenger's cabin seating group level, etc.) which influence when one or more deferred announcements are triggered for playout to seat VDU of the identified passenger.

The scheduling module may be operative to defer distribution of at least part of a user announcement to an identified one of the VDUs based on triggering display of a query message on the identified one of the VDUs (e.g., display a passenger selectable skip button on the seat VDU) and responsively receiving a query response (e.g., user touch selection of skip) from the identified one of the VDUs indicating a user's request to defer playout of the user announcement.

When a pre-recorded announcement is available in multiple available languages, the operations may auto-select one of the languages based on passenger preference or passenger selected language for interaction with a passenger interface of the IFE VDU, e.g., passenger selection of a preferred language among a list of available languages. When the announcement is available in the passenger selected language, the operations can automatically select the announcement in that preferred language and distributed the announcement to the passenger's VDU and skip the rest of the announcement languages or may queue the other announcement languages as non-mandatory announcements for adding to the deferred playout queue if or when an associated rule becomes satisfied. If the preferred announcement languages is not available, then a default language pre-recorded announcement may be played through the passenger's VDU.

The passengers preferred language may be determined based on a passenger's language selection through the VDU (e.g., selected language among a list of available languages), based on passenger language preference in a passenger manifest which is accessible to the server, or based on other obtained passenger information (e.g., passenger's citizenship, home country, home city, etc.).

In a further related example, the scheduling module is operative to identify a preferred announcement language based on obtaining an indication of a language preference that has been selected by a user for operation of an identified one of the VDUs or based on determining a language preference of the user from user defined information and/or home location of the user. The module then distributes a user announcement with spoken and/or written content in the preferred announcement language for playout through the identified one of the VDUs and defers distribution of another language version of the user announcement with the spoken and/or written track in a language other than the preferred announcement language.

Example deferred announcement rules are now described that can be defined in the repository to control 114 playout 112 of deferred announcements in the queue 110 to passenger VDUs or purge 112 of deferred announcement from the queue 110.

One type of deferred announcement rule identifies a maximum time limit that is allowed since initiating deferral of the user announcement without having completed playout. The scheduling module is operative to trigger distribution of the user announcement from the queue to the at least one of the VDUs based on when the maximum time limit has expired since initiating deferral of the user announcement without having completed playout of the user announcement by the at least one of the VDUs, wherein the scheduling model does not trigger the distribution of the user announcement to any of the VDUs that have at least partially begun playout of the user announcement before the maximum time limit has expired.

Another type of deferred announcement rule identifies that playout of the user announcement is required before the aircraft enters or leaves a defined flight phase. The scheduling module is operative to trigger distribution of the user announcement from the queue to the at least one of the VDUs based on determining the deferred announcement rule has become satisfied by the aircraft presently entering or exited the defined flight phase without having begun playout of the user announcement by the at least one of the VDUs.

Another type of deferred announcement rule identifies that playout of the user announcement is required before a flight time deadline. The scheduling module is operative to trigger distribution of the user announcement from the queue to the at least one of the VDUs based on determining the deferred announcement rule has become satisfied by the aircraft having been in flight for a time duration that satisfies the flight time deadline without having begun playout of the user announcement by the at least one of the VDUs.

Another type of deferred announcement rule identifies that playout of the user announcement is required before a threshold remaining flight time is reached. The scheduling module is operative to trigger distribution of the user announcement from the queue to the at least one of the VDUs based on determining the deferred announcement rule has become satisfied by the aircraft being estimated to have no more than the threshold remaining flight time before reaching a destination.

Another type of deferred announcement rule identifies that playout of the user announcement is required before or upon initiating a defined flight service (e.g., beverage service, food service, distribution of arrival customs papers within cabin, etc.). The scheduling module is operative to trigger distribution of the user announcement from the queue to the at least one of the VDUs based on determining the deferred announcement rule has become satisfied by the defined flight service being initiated without having begun playout of the user announcement by the at least one of the VDUs.

Another type of deferred announcement rule identifies that playout of the user announcement is permitted to be initiated when aircraft location enters or exits a defined geographic space. The scheduling module is operative to trigger distribution of the user announcement from the queue to the at least one of the VDUs based on determining a present aircraft location has entered or departed the defined geographic space identified by the deferred announcement rule without having begun playout of the user announcement by the at least one of the VDUs.

The deferred announcement rule may define that a queued announcement is to be triggered for playout responsive to an indication that a passenger has acted to pause or stop play of content through the passenger's VDU or that the content play has otherwise be paused, e.g., by the VDU identifying the passenger is inattentive, or stopped, e.g., by the content playout having completed. In a further example, the deferred announcement rule identifies that playout of a user announcement stored in a queue of deferred announcements is to be deferred while playout of entertainment content through a VDU is ongoing. The scheduling module is operative to determine that playout of entertainment content by an identified one of the VDUs has been paused or stopped, and trigger distribution of the user announcement from the queue to the identified one of the VDUs based on the determination satisfying the deferred announcement rule.

A passenger may be provided the ability to select and complete playout of announcements before boarding the aircraft, e.g., via the passenger's electronic device (e.g., smartphone, table computer, laptop computer, etc.) or after boarding the aircraft. Thus, for example, before boarding or while awaiting takeoff, a passenger may elect to view or listen to selected mandatory and/or non-mandatory announcements to avoid interruption with such completed announcements later during travel. In one operational embodiment, the deferred announcement rule can identify that playout of a user announcement is not to occur for users who have pre-completed playout of the user announcement. The scheduling module can then be operative to determine that a user of an identified one of the VDUs has pre-completed playout of the user announcement through the identified one of the VDUs, and prevent distribution of the user announcement from the queue to the identified one of the VDUs based on the determination satisfying the deferred announcement rule.

Thus, the scheduling module can be operative to determine that the user of the identified one of the VDUs has pre-completed playout of the user announcement through a portable electronic device of the user before boarding a vehicle transporting the entertainment system.

In a further implementation, the scheduling module is operative to display to the user of the identified one of the VDUs a listing of user announcements that are to be played to the user before completing travel on a vehicle transporting the entertainment system. Responsive to user commands received through the identified one of the VDUs to play selected ones of the user announcements, the operations distribute the selected ones of the user announcements to the identified one of the VDUs for playout, and updating the listing of user announcements to indicate which of the user announcements have completed playout by the identified one of the VDUs. The operations can then selectively defer distribution of the user announcements remaining in the list that have not completed playout by the identified one of the VDUs until deferred announcement rules associated with respective ones of the remaining user announcements in the list become satisfied.

The deferred announcement rule may identify that playout of a user announcement is not to occur while passengers are inattentive to associated VDUs. The scheduling module can then be operative to determine when a user has transitioned from being inattentive to being attentive to an identified one of the VDUs, and trigger distribution of the user announcement to the identified one of the VDUs based on the determination satisfying the deferred announcement rule. Attentiveness may be determined by the server based on indications of passenger interaction or lack of interaction with a VDU, duration of an idle mode of a VDU (e.g., displaying a menu without receiving user interaction, etc.), indications of passenger movement or lack of movement as identified in a video stream from a passenger facing camera, etc.

The deferred announcement rule may be defined for a user announcement and identifies that playout of a user announcement is not to occur while passengers are inattentive to associated VDUs. The scheduling module can be operative to determine when a user has transitioned from being inattentive to being attentive to an identified one of the VDUs, and trigger distribution of the user announcement to the identified one of the VDUs based on the determination.

The deferred announcement rule may be defined for a user announcement and identifies a content playout status for content being played through a VDU that serves as a trigger for distributing the user announcement to the VDU. The scheduling module can be operative to determine when the content playout status for content being played through an identified one of the VDUs satisfies the deferred announcement rule and responsively trigger distribution of the user announcement to the identified one of the VDUs.

The deferred announcement rule may be determined to be satisfied when the scheduling module determines that the remaining playout time for the content being streamed through the identified one of the VDUs is less than a defined threshold. Alternatively or additionally, the deferred announcement rule may be determined to be satisfied when the scheduling module determines that time to next commercial in the content being streamed through the identified one of the VDUs is less than a defined threshold. Alternatively or additionally, the deferred announcement rule may be determined to be satisfied when the scheduling module determines that time to next scene change in the content being streamed through the identified one of the VDUs is less than a defined threshold. Alternatively or additionally, the deferred announcement rule may be determined to be satisfied when the scheduling module determines that an operational level of interactive gaming content has been completed by a user playing through the identified one of the VDUs.

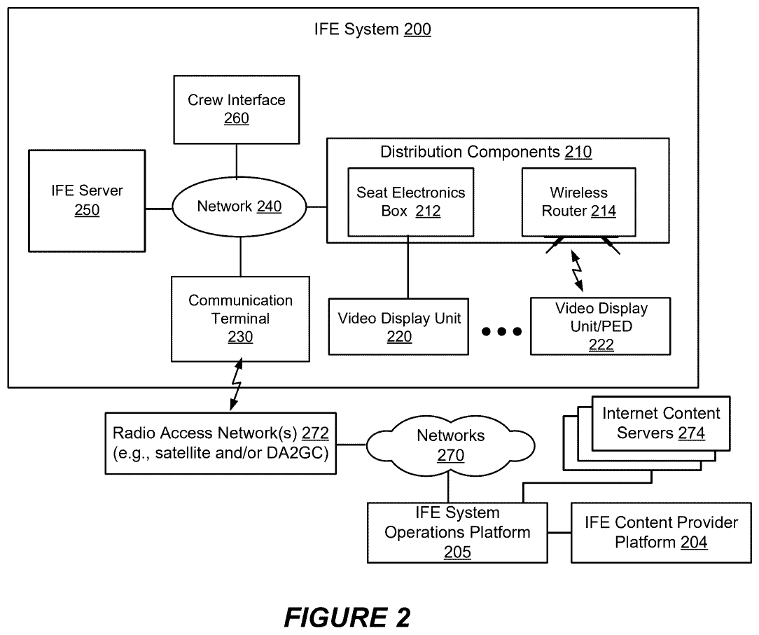

FIG. 2 illustrates a simplified block diagram of an IFE system 200 that is configured to control delivery of passenger announcements to passengers based on deferred announcement rule in accordance with some embodiments.

Referring to FIG. 2, the IFE system 200 includes video display units (VDUs) 220 and portable electronic devices (PEDs) 222 that communicate through communication distribution components 210 with an IFE server 250 and communication terminal 230. Some VDUs communicate through wired networks (e.g., ethernet) via seat electronics boxes 212, and other VDUs and PEDs 222 communicate through wireless router(s) 214, such as WiFi access point and/or cellular access point (e.g., a pico-cell radio base station) of distribution components 210. The VDUs can include, without limitation, seat displays which are mounted to individual seats, e.g., seatbacks or armrests, and PEDs. Example PEDs 222 transportable onto the aircraft can include, without limitation, smart phones, tablet computers, laptop computers, gaming computers, etc.

PEDs 222 can be communicatively connected to the IFE server 250, for example, using WiFi communications routed through the wireless router 214 and/or using Bluetooth communications routed through Bluetooth pairings between PEDs and VDUs 220. The IFE server 250 can determine which PEDs are associated with which passengers based on information gathered during pairing of PEDs to the aircraft network, based on information obtained from an airline application or other application on the PEDs, etc.

The IFE server 250 can provide broadcast and/or on-demand distribution of passenger-requested content to passengers. The IFE server 250 may receive announcements from a crew interface 260 and cockpit equipment through network 240. The communication terminal 230 can communicate through satellite networks with ground-based radio access network(s) 272 (e.g., ground relays) and may through direct-air-to-ground communications (DA2GC) communicate with cellular 3GPP NR 5G base stations (e.g., eNodeBs, gNodeBs, etc.), etc. In some optional embodiments, the IFE system 200 communicates through the wireless networks with an IFE system operations platform 205 which controls access to content from an IFE content provider platform 204 and/or other networked content servers such as Internet content servers 274.

The IFE server 200 can be connected through the network 240 to identify defined events, such as cabin doors open/closed indications, takeoff/landing based on weight-on-wheels indications, turbulence indications, etc. Passenger announcements can be triggered by such events, including pre-takeoff passenger briefings, return to seats and seatbelt indications, etc. Announcements can also be triggered by pilot and crew selections made through the cockpit and crew interface 260.

### Further Definitions and Embodiments

In the above description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout.

Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a non-transitory computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A non-transitory computer-readable medium may include an electronic, magnetic, optical, electromagnetic, or semiconductor data storage system, apparatus, or device. More specific examples of the computer-readable medium would include the following: a portable computer diskette, a random-access memory (RAM) circuit, a read-only memory (ROM) circuit, an erasable programmable read-only memory (EPROM or Flash memory) circuit, etc.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A computer server of an entertainment system comprising:
at least one network interface;
at least one processor connected to communicate through the at least one network interface with video display units (VDUs); and
at least one memory comprising:
an entertainment module operative to distribute entertainment content through the at least one network interface for playout through the VDUs;
a user announcement distribution module operative to distribute user announcements through the at least one network interface to the VDUs for playout as video on display devices and/or audio through audio interfaces; and
a scheduling module operative to selectively defer distribution of at least part of the user announcements through the at least one network interface to the VDUs based on at least one deferred announcement rule.

2-3. (canceled)

4. The computer server of claim 1, wherein the scheduling module is operative to selectively defer distribution of at least part of a user announcement to the VDUs based on:
receiving a user announcement including a tag indicating deferability of the user announcement;
based on the tag indicating the user announcement is not to be deferred, distribute the user announcement through the at least one network interface to the VDUs for playout without deferral; and
based on the tag indicating the user announcement can be deferred, store the user announcement in a queue of deferred announcements, identify an association between the user announcement and a deferred announcement rule, and distribute the user announcement from the queue for playout by at least one of the VDUs based on when the deferred announcement rule becomes satisfied.

5. The computer server of claim 4, wherein:
the deferred announcement rule identifies a maximum time limit that is allowed since initiating deferral of the user announcement without having completed playout, and
the scheduling module is operative to trigger distribution of the user announcement from the queue to the at least one of the VDUs based on when the maximum time limit has expired since initiating deferral of the user announcement without having completed playout of the user announcement by the at least one of the VDUs, wherein the scheduling model does not trigger the distribution of the user announcement to any of the VDUs that have at least partially begun playout of the user announcement before the maximum time limit has expired.

6. The computer server of claim 4, wherein:
the deferred announcement rule identifies that playout of the user announcement is required before the aircraft enters or leaves a defined flight phase; and
the scheduling module is operative to trigger distribution of the user announcement from the queue to the at least one of the VDUs based on determining the deferred announcement rule has become satisfied by the aircraft presently entering or exited the defined flight phase without having begun playout of the user announcement by the at least one of the VDUs.

7. The computer server of claim 4, wherein:
the deferred announcement rule identifies that playout of the user announcement is required before a flight time deadline; and
the scheduling module is operative to trigger distribution of the user announcement from the queue to the at least one of the VDUs based on determining the deferred announcement rule has become satisfied by the aircraft having been in flight for a time duration that satisfies the flight time deadline without having begun playout of the user announcement by the at least one of the VDUs.

8. The computer server of claim 4, wherein:
the deferred announcement rule identifies that playout of the user announcement is required before a threshold remaining flight time is reached; and
the scheduling module is operative to trigger distribution of the user announcement from the queue to the at least one of the VDUs based on determining the deferred announcement rule has become satisfied by the aircraft being estimated to have no more than the threshold remaining flight time before reaching a destination.

9. The computer server of claim 4, wherein:
the deferred announcement rule identifies that playout of the user announcement is required before or upon initiating a defined flight service; and
the scheduling module is operative to trigger distribution of the user announcement from the queue to the at least one of the VDUs based on determining the deferred announcement rule has become satisfied by the defined flight service being initiated without having begun playout of the user announcement by the at least one of the VDUs.

10. The computer server of claim 4, wherein:
the deferred announcement rule identifies that playout of the user announcement is permitted to be initiated when aircraft location enters or exits a defined geographic space; and
the scheduling module is operative to trigger distribution of the user announcement from the queue to the at least one of the VDUs based on determining a present aircraft location has entered or departed the defined geographic space identified by the deferred announcement rule without having begun playout of the user announcement by the at least one of the VDUs.

11. The computer server of claim 1, wherein:
the deferred announcement rule identifies that playout of a user announcement stored in a queue of deferred announcements is to be deferred while playout of entertainment content through a VDU is ongoing; and
the scheduling module is operative to determine that playout of entertainment content by an identified one of the VDUs has been paused or stopped, and trigger distribution of the user announcement from the queue to the identified one of the VDUs based on the determination satisfying the deferred announcement rule.

12-21. (canceled)

22. A method performed by a computer server of an entertainment system, the method comprising:
distributing entertainment content through at least one network interface of the computer server for playout through video display units (VDUs) communicatively connected to the computer server through the at least one network interface;
distributing user announcements through the at least one network interface to the VDUs for playout as video on display devices and/or audio through audio interfaces; and
selectively defer distribution of at least part of the user announcements through the at least one network interface to the VDUs based on at least one deferred announcement rule.

23. The method of claim 22, wherein the method further comprises selectively deferring distribution of at least part of a user announcement to the VDUs based on:
receiving a user announcement including a tag indicating deferability of the user announcement;
based on the tag indicating the user announcement is not to be deferred, distribute the user announcement through the at least one network interface to the VDUs for playout without deferral; and
based on the tag indicating the user announcement can be deferred, store the user announcement in a queue of deferred announcements, identify an association between the user announcement and a deferred announcement rule, and distribute the user announcement from the queue for playout by at least one of the VDUs based on when the deferred announcement rule becomes satisfied.

24. The method of claim 23, wherein:
the deferred announcement rule identifies a maximum time limit that is allowed since initiating deferral of the user announcement without having completed playout, and
the method further comprises:
triggering distribution of the user announcement from the queue to the at least one of the VDUs based on when the maximum time limit has expired since initiating deferral of the user announcement without having completed playout of the user announcement by the at least one of the VDUs, and
not triggering the distribution of the user announcement to any of the VDUs that have at least partially begun playout of the user announcement before the maximum time limit has expired.

25. The method of claim 23, wherein:
the deferred announcement rule identifies that playout of the user announcement is required before the aircraft enters or leaves a defined flight phase; and
the method further comprises triggering distribution of the user announcement from the queue to the at least one of the VDUs based on determining the deferred announcement rule has become satisfied by the aircraft presently entering or exited the defined flight phase without having begun playout of the user announcement by the at least one of the VDUs.

26. The method of claim 23, wherein:
the deferred announcement rule identifies that playout of the user announcement is required before a flight time deadline; and
the method further comprises triggering distribution of the user announcement from the queue to the at least one of the VDUs based on determining the deferred announcement rule has become satisfied by the aircraft having been in flight for a time duration that satisfies the flight time deadline without having begun playout of the user announcement by the at least one of the VDUs.

27. The method of claim 23, wherein:
the deferred announcement rule identifies that playout of the user announcement is required before a threshold remaining flight time is reached; and
the method further comprises triggering distribution of the user announcement from the queue to the at least one of the VDUs based on determining the deferred announcement rule has become satisfied by the aircraft being estimated to have no more than the threshold remaining flight time before reaching a destination.

28. The method of claim 23, wherein:
the deferred announcement rule identifies that playout of the user announcement is required before or upon initiating a defined flight service; and
the method further comprises triggering distribution of the user announcement from the queue to the at least one of the VDUs based on determining the deferred announcement rule has become satisfied by the defined flight service being initiated without having begun playout of the user announcement by the at least one of the VDUs.

29. The method of claim 23, wherein:
the deferred announcement rule identifies that playout of the user announcement is permitted to be initiated when aircraft location enters or exits a defined geographic space; and
the method further comprises triggering distribution of the user announcement from the queue to the at least one of the VDUs based on determining a present aircraft location has entered or departed the defined geographic space identified by the deferred announcement rule without having begun playout of the user announcement by the at least one of the VDUs.

30. The method of claim 22, wherein:
the deferred announcement rule identifies that playout of a user announcement stored in a queue of deferred announcements is to be deferred while playout of entertainment content through a VDU is ongoing; and
the method further comprises:
determining that playout of entertainment content by an identified one of the VDUs has been paused or stopped, and
triggering distribution of the user announcement from the queue to the identified one of the VDUs based on the determination satisfying the deferred announcement rule.
